(19) United States
(12) Patent Application Publication
(10) Pub. No.: US 2007/0130474 A1
(43) Pub. Date: Jun. 7, 2007

(54) Creating multiple one-time passcodes

(75) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TRI-D Systems, inc., Pasadena, CA (US)

(21) Appl. No.: 11/633,950

(22) Filed: Dec. 4, 2006

Related U.S. Application Data
(60) Provisional application No. 60/742,512, filed on Dec. 5, 2005.

(51) Int. Cl. H04L 9/32; H04K 1/00; H04L 9/00; G06K 9/00; G06F 15/16; G06F 17/30; G06F 7/04; G06F 7/58; H03M 1/68; G06K 19/00; H04N 7/16

(52) U.S. Cl. 713/184; 726/27; 726/5; 713/185; 726/9

(57) ABSTRACT

In one embodiment of a method of and system for creating one-time-passcodes, a one-time-passcode is created using a value representing the time on a clock. Where a second or subsequent one-time passcode is required before the time value has incremented, the time value is modified and the second or subsequent passcode is created using the modified time value. The modified time value does not represent a time on the clock within a predetermined period of the actual time on the clock. Otherwise unused most-significant bits of the clock value may be modified.

### CROSS REFERENCE TO RELATED APPLICATIONS

This application claims benefit of U.S. Provisional Patent Application No. 60/742,512, filed Dec. 5, 2005, which is incorporated herein by reference in its entirety. This application is related to U.S. patent application Ser. No. 11/______ (attorney docket no. 46428-0011-00-US), filed concurrently herewith for “Synchronizing Token Time Base,” which is incorporated herein by reference in its entirety.

### BACKGROUND

The present invention relates to time-based authentication tokens and devices.

Authentication tokens are available that present a one-time-passcode (OTP), which the user uses to authenticate himself or herself to a resource or facility, for example, a server or application. For conciseness, the server, application, or other resource or facility is referred to below generally as a “server.” In general, the term “server” is to be understood as denoting any device or system capable of receiving and validating an OTP from an authentication token. The server typically maintains a list of authorized users, usually human individuals, and the token each user has been assigned. The server or application also has a method by which it stays synchronized with each token, so the server can determine what OTP it expects from the token on each occasion when an alleged OTP is presented.

Typical one-time authentication tokens use a strong encryption method for generating the OTP. Typically each token uses a unique “random” encryption key. When a token is issued to a user the server is given information about the user and the token issued to the user. This information typically includes the user's login name and password, the encryption key of the token, and the initial value of a variable used to generate the sequence of OTPs.

One-time authentication tokens may be either event-based or time-based. Event-based tokens use a counter as the basis for generating a sequence of OTPs. An event-based one-time authentication token may be initialized by presetting the token and the server to the same known point in the token's sequence. The counter is incremented in a known method and with each use the token and the server increment synchronized counters with similar methods. If the OTP presented by the user is the same as the OTP generated by the server for that user, then the user is granted access to the server or other controlled resource. By storing the state of the counter, the token and the server then remain synchronized from use to use. Some event-based one-time authentication token servers will accept any of the next few passcodes along the sequence, allowing the server to resynchronize with the token if for any reason one or a few passcodes have been skipped.

Time-based tokens rely on a clock as the basis for generating the one-time-passcode. Self-contained time-based tokens include the clock in the token itself. This clock is typically a real-time-clock (RTC) and the generated one-time-passcode is based on a known method using this RTC. The server maintains a list for each token, including an initial time-base for each token and uses a similar method for generating OTPs. The server uses a standard time source for its own RTC, and if the OTP presented by the user's token is the same as the OTP generated by the server for that user at that time, then the user is granted access to the server or other resource controlled by the server.

It is sometimes necessary for a user to provide several OTPs in quick succession, either as an additional security precaution or to authenticate himself to different servers as part of a complex login procedure. With an event-based token, the user can repeatedly activate the token, and receive a different passcode each time. However, with a time-based token, it is common for the passcode to be based on coarse intervals of time, for example, one minute, so that a new passcode is available only once per minute.

There is therefore a continuing need for methods and systems that can enable a time-based token to provide two or more different passcodes without waiting for the next clock interval.

### SUMMARY

Embodiments of the present invention are directed to time-based authentication tokens, and to generating and recognizing multiple passcodes from time-based authentication tokens.

In one embodiment of the invention, there are provided a method of and system for creating one-time-passcodes, comprising creating a one-time-passcode using a value representing the time of a clock, and where a second one-time passcode is required before the time value has incremented, modifying the time value and creating the second passcode using the modified time value, wherein the modified time value does not represent a time of the clock within a predetermined period of the actual time of the clock.

The system may comprise an authenticating token.

In another embodiment of the invention, there are provided methods and systems for authenticating one-time passcodes, comprising receiving a purported one-time-passcode, on at least some occasions generating an unmodified expected passcode using a value representing the time at which the purported one-time-passcode is received, on at least some occasions modifying the time value and creating a modified expected passcode using the modified time value, wherein the modified time value does not represent a time on a real-time clock within a predetermined period of the actual time on the real-time clock, and granting or denying authentication depending at least in part on whether the received purported passcode matches the generated expected passcode.

The system may be embodied at least in part using one or more computers, and another embodiment of the invention provides programs for causing a computer to carry out the methods of the invention.

In a further embodiment of the invention, there is provided a software program which, when running on a computing system is arranged to cause the computing system to carry out a method of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram of an embodiment of a token according to the present invention.

FIG. 2 is a schematic diagram of an embodiment of a computer system according to the present invention.

FIG. 3 is a flowchart of an embodiment of the present invention.

### DETAILED DESCRIPTION

Reference will now be made in detail to various embodiments of the present invention, examples of which are illustrated in the accompanying drawings.

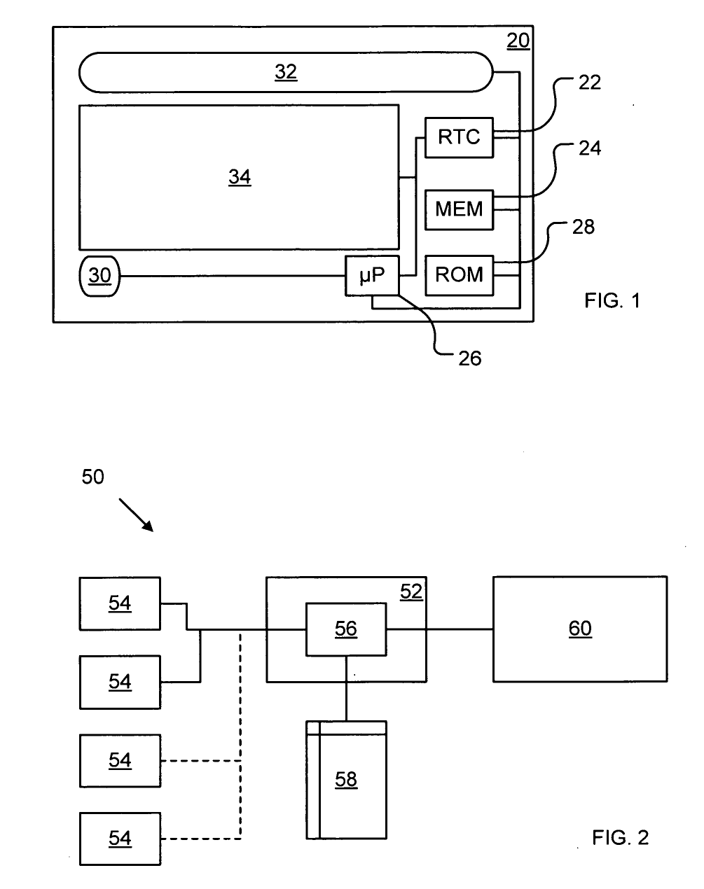

Referring to the drawings, and initially to FIG. 1, one form of token constructed in accordance with an embodiment of the present invention, indicated generally by the reference numeral 20, comprises a device substantially the size and shape of a credit card, that is to say, approximately 85 mm by 54 mm by 0.8 mm thick. The token 20 comprises a real-time clock (RTC) 22, a memory 24, which may be a non-volatile memory, for storing a unique key, a processor 26, a program ROM 28 containing a program for the processor, an actuation button 30 on the exterior of the token, a display 32 on the exterior of the token, and a battery 34.

When the token 20 is active, operating the button 30 causes the processor 26 to run the program from the ROM 28, generate a one-time-passcode (OTP) using the time from the RTC 22 and the unique key from the memory 24, and display the OTP on the display 32.

The unique key in the memory 24 may be, for example, an encryption key or a hashing key. A hashing key that returns a hash value of constant length irrespective of the time value received from the RTC 22 is presently preferred. However, other forms of key currently available or hereafter to be developed may be used, typically incorporating or in combination with some form of encryption, provided that the function of generating an OTP is effectuated. Typically, the OTP should be generated using the key in the memory 24 and the time according to the RTC 22 in such a way that current or future OTPs from a given token 20 cannot easily be predicted even with detailed knowledge of other similar tokens 20 and with knowledge of recent earlier OTPs from the given token 20. The token 20 may use any suitable method of generating an OTP that meets those objectives to a desired standard.

The OTP is displayed for a short period, which may be programmed or may be, for example, only as long as the button 30 is held. The token 20 then returns to a standby mode in which the RTC 22 continues to run, and the memory 24 is maintained, but all other functions are shut down to save power.

The token 20 may return immediately from the active mode to the standby mode, or may pass through an intermediate mode in which, for example, the display 32 is shut down but the OTP is held in memory and/or the processor 26 remains active, so that the OTP can be recalled to the display or a new OTP can be generated quickly. The memory 24 may be a non-volatile memory that requires no power to maintain it, or may be a memory requiring a very low power supply. The processor 26 may stand by at a very low level of activity to monitor for actuation of the button 30, or the processor may be entirely shut down until actuation of the button 30 closes a contact to supply power to the processor. The main load on the battery 34 in the standby mode is the RTC 22.

The program is commonly arranged to use only a coarse value of the time from the RTC 22 to generate the OTP, for example, the time to the nearest minute. That has an important practical advantage, because in a real system, especially one that involves a human user reading and keying in the passcode, a delay of several seconds may occur between the OTP being generated and the OTP being transmitted to a server that is to authenticate the OTP. If the clocks tick over a minute during that delay, the token 20 and the server may be one passcode out of step. If the clock cycle is shorter or the transmission delay is longer, a discrepancy of more than one step in the sequence of passcodes may occur. The server may therefore be programmed to generate a range of successive passcodes for times equal to or offset from the exact time indicated by the server's master clock, and to accept any of those passcodes from the token user. However, the shorter the interval at which the RTC 22 increments its input to the program that generates the OTP is in relation to the maximum tolerated transmission delay, the more passcodes the server must generate and accept. That both increases the computational load on the server and reduces the security of the system.

Referring to FIG. 2, a computer system indicated generally by the reference numeral 50 comprises an authentication server 52 and various user terminals or other access points 54. The system 50 may comprise several authentication servers 52, only one of which is shown in FIG. 2. The user terminals 54 may be, for example, computers connected to the server 52 over the internet or other wired or wireless networks. The server 52 comprises a processor 56, which maintains a database 58 of the authentication tokens 20 authorized for use on that network. For each token 20, the database 58 may contain the username and password of the authorized user, the key in the memory 24 (or, in the case of a one-way cipher, the decryption key corresponding to the encryption key in the memory 24), and the offset between the RTC 22 and the server's standard clock. If the program that generates the OTP from the key and the time from the RTC 22 is not standard for all tokens 10 in the system, then the program for each token is also included in the database 58.

The authentication server 52 grants or denies users at terminals 54 access to other computing resources 60. The authentication server 52 may control access to multiple resources 60, which may require separate logins.

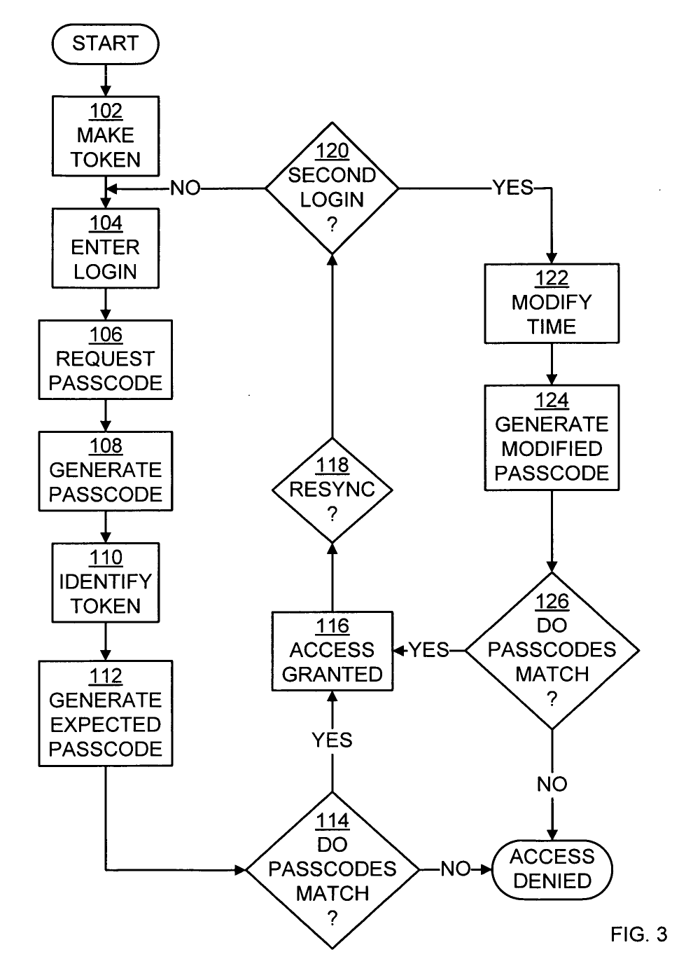

Referring now to FIG. 3, in an embodiment of a process according to the invention, in step 102 a token 20 is manufactured, with the key loaded into the memory 24 and the RTC 22 running. The token 20 does not need to be brought into that state when it is manufactured. For example, co-pending application Ser. No. 11/______ for “Token time-base” describes a procedure in which the manufacture of the token, the loading of the key, and the starting of the clock may be three distinct procedures spaced apart in time.

To access the computing resources 60, the user at a terminal 54 logs in through the authentication server 52. In step 104, the user gives a user login name and password. In step 106, the server 52 requires an OTP from the token 20 assigned to the user. In step 108, the user presses the button 30. The processor 26 becomes active, loads the program from the ROM 28 and the key from the memory 24, reads the time from the RTC 22, generates an OTP, and displays the OTP on the display 32. In the interests of clarity, steps 104, 106, and 108 are shown as distinct steps. In a practical embodiment, they may be combined, for example, in the form of a login screen that requires the user login name, password, and OTP to be entered in a single form.

In step 110, the server 52 looks up the user login name in the database 58, checks that the password is correct for that login name, and identifies the appropriate token 20 from the database 58. In step 112, the server calculates the OTP that it expects to receive at that time from the identified token 20, and in step 114 determines whether the expected OTP matches the OTP actually received. If the expected and received OTPs match, in step 116 the user is granted access to the resources 60, to the extent proper to the identified user.

In step 118, the server 52 checks for the accuracy of the RTC 22 in the token 20. The server 52 may be programmed to accept an OTP that is correct for a time slightly before or slightly after the time shown by the server's master clock (after correcting for the starting time of the RTC 22), and to adjust the recorded starting time of the RTC to resynchronize the RTC with the master clock. If the type of RTC 22 used is prone to drift at a steady rate that varies from one individual clock to another, the server 52 may be programmed to determine and expect the drift rate.

The time from the RTC 22 used in step 108 may be, for example, a time in minutes starting from some zero point “known” to both the RTC 22 and the server 52. For example, co-pending application Ser. No. 11/______ for “Synchronizing token time-base” describes a procedure for initializing a token 20 so that the server 52 can determine the time zero point of the RTC 22. Where the RTC starts from a value of zero minutes, a 32 bit number allows the clock to run for over 8,000 years before the number overflows back to zero. It is unlikely that any token 20 manufactured with current technology will remain in operation for even a fraction of that period. Therefore, the program that generates the OTP is designed to generate satisfactorily unique OTPs even when using a time value of which the most significant bits are predictably zero. For example, certain hash functions can produce a hash value of constant length even when hashing numbers in which a substantial but variable number of the most significant digits are zero. Alternatively, the RTC 22 may be programmed to start, not from zero, but from an arbitrary value known to the authentication server 52 that pre-fills the most significant digits of the 32 bit time field with a satisfactory mixture of 1s and 0s.

In step 120, the user attempts to log in to another resource 60, at the same or another authentication server 52, within the same minute in which the user provided an OTP in step 108. In step 122, the program in the token 20 modifies the time from the RTC 22 by changing one of the most significant bits of the time value. Conceptually, the 32-bit time value may be divided into, for example, a 28-bit time value (allowing approximately 500 years before the time value overflows) and a 4-bit value used only for step 122, but physical segregation of sub-fields within the 32-bit value is not required.

In step 124, the program generates an OTP from the modified time value, and the user sends the OTP to the authentication server 52. In step 126, the authentication server 52 receives the OTP from the token 20, calculates the OTP that it expects to receive at that time from the identified token 20, and determines whether the expected OTP matches the OTP actually received. If the expected and received OTPs match, the user is granted access to the resources 60, to the extent proper to the identified user.

If the authentication server 52 in step 126 is the same server as in step 110, the server 52 detects that it has received two OTPs from the same token 20 in the same minute, and requires that the second OTP be the modified OTP generated in step 124. If the authentication servers 52 in steps 110 and 126 are distinct, they may notify each other of logins, so that the authentication server in step 126 knows to require the modified OTP.

If the authentication servers 52 in steps 110 and 126 are distinct and not closely cooperating, then the authentication servers 52 in step 126 does not know whether the token 20 has issued a previous OTP in the same minute, and must accept either the normal or the modified OTP for that minute. Even in that case, however, generating the modified OTP has security benefits, because it conceals from an eavesdropper the fact that the authentication servers 52 in steps 110 and 126 would have accepted the same OTP, and thus conceals a potential vulnerability.

As is shown symbolically by the loop through steps 116 through 126 in FIG. 3, more than one modified passcode may be obtained and used in one minute. In order to ensure that all passcodes are unique, each repetition of step 122 further increments the 4-bit number forming the most significant part of the 32-bit time value. Allowing the four most significant bits of the 32 bit time value for the generation of modified OTPs permits up to 16 unique OTPs to be generated in any one minute. It is unlikely that a normal human user would be able to operate the token 20 and the terminal 54 fast enough to require more than 16 OTPs in any one minute. However, the number of bits assigned to the time and the number of bits assigned to the modification may be altered to suit the requirements of a specific system 50. The total number of bits used as input to the hash function may be varied, but should be sufficient to contain in binary form the expected lifetime of the token 20 expressed as a multiple of the fastest rate at which a user is expected to require OTPs.

The system described above with reference to FIGS. 1 to 3 is highly compatible with conventional tokens that generate one OTP per minute. A mixture of conventional tokens and tokens 20 that embody the invention may be used, and those tokens may be indistinguishable in normal use, except when a second OTP in a single minute is desired. The present system may therefore be introduced to an existing system 50, simply by adding a small amount of additional program code to the authentication server 52 to generate and verify the modified passcodes, and gradually introducing the present tokens 20 in place of the previous tokens.

Therefore, the present device makes it possible to solve, or substantially mitigate, problems of time-based authentication tokens.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention.

For example, the token 20 has been described as cooperating with an authentication server 52 that allows or denies access to computing resources 60. The authentication may instead be managed directly by an application that the user desires to access. The one-time passcode may alternatively be used to access any resource that is controlled by a passcode, for example, as an access code on a door to a physical facility. The passcode has been described as being read off a display 32, but may alternatively be transmitted directly to the authentication server 52 or other recipient if the token 20 is, for example, a smartcard with electronic data contacts, or a PC card or other device that can be plugged into a computer or other electronic device. Electronic transmission of passcodes may increase the rate at which passcodes can be generated and transmitted, and may make it desirable to increase the maximum number of modified passcodes per minute.

The user has been described as entering a user login name and password as well as the OTP. Alternatively, or in addition, other methods, known or hereafter to be developed, of identifying the user may be used. For example, biometric data may be used. The token 20 itself may be a biometric card as described in my U.S. Patent Application No. 2004/0030660.

Where an OTP or other datum is described as unique, universal uniqueness is not required. Local uniqueness within the system 50 is generally sufficient, and statistical local uniqueness, in the sense that a duplicate is highly unlikely to occur, is typically adequate provided that the statistical likelihood of a duplication is set sufficiently low for the requirements of a given system.

In the interests of linguistic simplicity, the delays arising between the moment when the user presses the button 30 and the moment when the server 52 authenticates the OTP have been ignored. However, in a real system, especially one that involves a human user reading and keying in the passcode, a delay of several seconds may occur. If the clocks tick over a minute during that delay, the token 20 and the server 52 may be one passcode out of step. If delays arise, a discrepancy of more than one step in the sequence of passcodes may occur, even without allowing a tolerance for clock drift. The server 52 may therefore be programmed to generate a range of successive passcodes for times equal to or offset from the exact time indicated by the master clock, and to accept any of those passcodes from the token user, with or without other constraints. It may be appropriate for the server 52 to accept either the normal passcode for the present minute or a modified passcode for a previous minute. References to the time or the passcode matching are to be understood accordingly as including, in appropriate cases, a match with an acceptable offset.

A token 20 that generates one different unmodified OTP every minute has been described. The time period at which the unmodified OTP changes may be more or less than a minute. A longer time period increases the need for modified OTPs, and increases the vulnerability if a snooper can log in to another resource by using an intercepted OTP within the same time period, but reduces the vulnerability caused by the authentication server 52 having to accept a list of recent OTPs in order to tolerate delays in submitting the OTP after it has been generated.

The modified bits have been described as being bits at the most significant end of the time field input to the hashing or other encryption algorithm, that are otherwise inactive in the sense that they would change only when representing times outside the expected lifetime of the token 20. The modified bits could instead be appended below the least significant bit of the time. In some implementations, the modified bits could overlap with active bits of the time value, although the time difference between the occurrence of an OTP as an unmodified passcode and the possible occurrence of the same OTP as a modified passcode is then preferably large. The modifying bits are then preferably at the extreme high end and in reverse order, to maximize the time difference. Where the time value used for generating the OTP is not expressed as a binary number, the same considerations may be applied analogously.

Thus, it is intended that the present invention cover the modifications and variations of this invention provided they come within the scope of the appended claims and their equivalents.

What is claimed is:

1. A method of creating one-time-passcodes, comprising:
creating a one-time-passcode using a value representing the time on a clock; and
where a second one-time passcode is required before the time value has incremented, modifying the time value and creating the second passcode using the modified time value;
wherein the modified time value does not represent a time on the clock within a predetermined period of the actual time on the clock.

2. A method according to claim 1, wherein the modified time value does not represent a time on the clock within the expected operating lifetime of the clock.

3. A method according to claim 1, wherein modifying the time value comprises modifying a most significant part of the time value.

4. A method according to claim 1, further comprising, where a further one-time passcode is required before the time value has changed, further modifying the time value and generating the further passcode using the further modified time value.

5. A method according to claim 1, further comprising receiving the created passcode, generating an expected passcode for the clock setting, and granting or denying access to a resource depending at least in part on whether the received passcode matches the expected passcode.

6. A method according to claim 5, wherein generating an expected passcode comprises determining whether a passcode has already been received from the same creator within the interval at which the time value increments and, if so, generating the modified passcode as the expected passcode.

7. A method according to claim 5, wherein generating an expected passcode comprises generating both an unmodified passcode and the modified passcode as expected passcodes, and granting or denying access to a resource depending at least in part on whether the received passcode matches either the modified or the unmodified expected passcode.

8. A method of authenticating one-time passcodes, comprising:
receiving a purported one-time-passcode;
on at least some occasions generating an unmodified expected passcode using a value representing the time at which the purported one-time-passcode is received;
on at least some occasions modifying the time value and creating a modified expected passcode using the modified time value;
wherein the modified time value does not represent a time within a predetermined period of the actual time; and
granting or denying authentication depending at least in part on whether the received purported passcode matches the generated expected passcode.

9. A method according to claim 8, further comprising determining whether a purported passcode from the same source has already been received within the interval at which the time value increments;
where a second purported one-time passcode is received before the time value has incremented, generating and using the modified expected passcode; and
where the received purported one-time passcode is the first purported passcode received for the present increment of the time value, generating and using the unmodified expected passcode.

10. A method according to claim 8, further comprising generating both the unmodified expected passcode and the modified expected passcode, and granting or denying authentication depending at least in part on whether the received purported passcode matches either of those generated expected passcodes.

11. A method according to claim 8, wherein granting or denying authentication further comprises granting or denying access to a resource.

12. A one-time-passcode authenticating token comprising:
a clock;
a unique key; and
a processor arranged to generate an unmodified one-time-passcode using the unique key and a value representing the time from the clock;
wherein the processor is operative, when a second one-time passcode is requested before the clock has incremented, to modify the time value and to generate a modified one-time-passcode using the unique key and the modified time value;
wherein the modified time value does not represent a time of the clock within a predetermined period of the actual time of the clock.

13. A token according to claim 12, wherein the modified time value does not represent a time of the clock within the expected operating lifetime of the clock.

14. A token according to claim 12, wherein the processor is operative to modify a most significant part of the time value.

15. A token according to claim 12, where the processor is operative, where a further one-time passcode is requested before the time value has changed, to further modify the time value and generate the further passcode using the further modified time value.

16. A token according to claim 12, wherein the unique key is an encryption key or a hashing key.

17. A token according to claim 12, in combination with a server arranged to receive a one-time passcode from the token, to determine at least an expected one of an expected unmodified passcode and an expected modified passcode for that token at that time, and to determine whether the received passcode matches the expected passcode.

18. A system for authenticating passcodes, arranged in operation to:
receive a purported one-time-passcode;
on at least some occasions generate an unmodified expected passcode using a value representing the time at which the purported one-time-passcode is received;
on at least some occasions modify the time value and generate a modified expected passcode using the modified time value;
wherein the modified time value does not represent a time on a real-time clock within a predetermined period of the actual time on the real-time clock; and
grant or deny authentication depending at least in part on whether the received purported passcode matches the generated expected passcode.

19. A system according to claim 18, further arranged in operation to:
determine whether a purported passcode from the same source has already been received within the interval at which the time value increments;
where a second purported one-time passcode is received before the time value has incremented, generate and using the modified expected passcode; and
where the received purported one-time passcode is the first purported passcode received for the present increment of the time value, generate and using the unmodified expected passcode.

20. A system according to claim 18, further arranged in operation to generate both the unmodified expected passcode and the modified expected passcode, and grant or deny authentication depending at least in part on whether the received purported passcode matches either of those generated expected passcodes.

21. A system according to claim 18, further arranged in operation to granting or denying authentication comprising granting or denying access to a resource.

22. A system according to claim 18, comprising a computing device comprising a program arranged when running to cause the computing device to carry out the said receiving, modifying, generating, and granting or denying.

23. A software program that when running on a computing system is arranged to cause the computing system to:
receive a purported one-time-passcode;
on at least some occasions generate an unmodified expected passcode using a value representing the time at which the purported one-time-passcode is received;
on at least some occasions modify the time value and generate a modified expected passcode using the modified time value;
wherein the modified time value does not represent a time on a real-time clock within a predetermined period of the actual time on the real-time clock; and
grant or deny authentication depending at least in part on whether the received purported passcode matches the generated expected passcode.

24. A software program according to claim 23, further arranged to cause the computing system to grant or deny access to one or more resources in dependence at least in part on the determination whether or not a received passcode matches an expected passcode.

25. A software program according to claim 23, embodied in a machine-readable medium.
